(19) United States
(12) Patent Application Publication
(10) Pub. No.: US 2020/0061741 A1
(43) Pub. Date: Feb. 27, 2020

(54) Immersion laser fabrication method and system

(71) Applicant: Nanoplus Ltd., Taipei (TW)

(72) Inventors: Alexander NAUMOV, Taipei (TW); Ilya VELIKOVSKIY, Taipei (TW)

(21) Appl. No.: 16/544,734

(22) Filed: Aug. 19, 2019

(30) Foreign Application Priority Data
Aug. 27, 2018 (TW) 107129739

(51) Int. Cl. B23K 26/0622; B23K 26/03; B23K 26/14

(52) U.S. Cl. CPC B23K 26/0622; B23K 26/0732; B23K 26/14; B23K 26/034

(57) ABSTRACT

The present invention discloses an immersion laser fabrication method and system, the method comprises providing a substrate with a first shape; disposing the substrate in a carrier, and a liquid is injected into the carrier; providing a laser source to generate a laser beam; cutting the substrate along a second shape by the laser beam based on an application program in order to separate the substrate into a main substrate and a sub-substrate, the sub-substrate is detached from the substrate and sinks to the bottom of the carrier, or the substrate is drilled by the laser beam based on the application program in order to form a hole and a derivative in the substrate, the derivative is detached from the substrate and sinks to the bottom of the carrier; and obtaining the main substrate, the substrate with the hole, or the main substrate with the hole.

### FIELD OF THE INVENTION

The present invention is a technical field of substrate fabrication, in particular, an immersion laser fabrication method and system thereof providing a clean process.

### BACKGROUND OF THE INVENTION

Conventional substrates (such as glass, sapphire, silicon, gallium arsenide or ceramic, etc.) are processed by a laser (for example, cutting or drilling) in order to obtain a corresponding shape and hole and in order to achieve a good yield and a fabrication quality.

Conventional laser fabrication requires the use of water, e.g. the water jet method commonly known. The water jet method can reduce a high temperature generated when the laser applied onto the substrate and can be used to clean debris. If the water is not used as a medium in processing, it will be difficult to achieve good yield and less effective during the substrate fabrication.

However, since the laser fabrication of the water jet method uses water jet method during the fabrication process, therefore the effects thereof will result in air pollution by ex. a glass particle generated during the fabrication process, and the air pollution will cause an occupational injury and especially lung damage amongst the operators and site staff. In addition, the glass particle affects a collimation, a strength, and etc. of the laser light source, resulting in a decrease yield. Furthermore, the water jet method is used dynamically, thus needs to maintain a stable flow rate, otherwise the result of the substrate cutting will be inconsistent. In addition to maintaining the flow rate, it is necessary to consider the spraying location of the nozzle, and the spraying location must to be accurate. Therefore, the size of the hole is limited to be only 0.2 to 0.25 mm when the hole processing is performed with the water jet method, due to many factors as described above.

In light of the above, the present invention provides an immersion laser fabrication method and system thereof to solve the conventional problem.

### SUMMARY OF THE INVENTION

In order to solve the above drawbacks, the first purpose of the present invention is to provide an immersion laser fabrication method providing a clean fabrication method used for immersing a substrate and fabricating by a method.

A second purpose of the present invention is to dispose a substrate on a carrier in accordance with the above-described immersion laser fabrication method in order to perform a cutting process, a hole drilling process or a combination thereof.

A third purpose of the present invention is to sink the substrate after cutting or sink a particle a scrap or a derivative after the drilling to a bottom of the carrier in accordance with the above-described immersion laser fabrication method in order to achieve the purpose without air pollution.

A fourth purpose of the present invention is to provide an immersion laser fabrication system in which a laser beam is transmitted through a mechanical assembly or scanning assembly to cause a laser beam to transmit along a path for fabrication.

A fifth purpose of the present invention is to provide an immersion laser fabrication system that provides a clean laser fabrication process.

In order to achieve the above and the other purposes, an immersion laser fabrication method is provided by the present invention. The immersion laser fabrication method comprises: providing a substrate with a first shape; disposing the substrate in a carrier, and a liquid is injected into the carrier; providing a laser source to generate a laser beam; cutting the substrate along a second shape by the laser beam based on an application program in order to separate the substrate into a main substrate and a sub-substrate, the sub-substrate is detached from the substrate and sinks to the bottom of the carrier, or the substrate is drilled by the laser beam based on the application program in order to form a hole and a derivative in the substrate, the derivative is detached from the substrate and sinks to the bottom of the carrier; and obtaining the main substrate, the substrate with the hole, or the main substrate with the hole.

In order to achieve the above and the other purposes, the present invention provides an immersion laser fabrication system used for fabricating the substrates. The immersion laser fabrication system comprises a carrier unit, a laser light source unit, a holding unit and a processing unit. The carrier unit is configured an accommodating space for injecting a liquid. The accommodating space is used for disposing the substrate, and wherein the substrate is covered by the liquid or at least a part of the substrate is exposed by the surface of the liquid. The laser light source unit is disposed on a side of the carrier unit. A laser beam is generated by the laser light source unit. The holding unit is disposed near the carrier unit or the laser light source unit, and the holding unit is used for holding the substrate in order to immerse the substrate into the liquid. The processing unit is connected to the laser light source unit. An application program is executed by the processing unit in order to cut the substrate into a main substrate and a sub-substrate or form a hole and derivatives in the substrate. Wherein the sub-substrate is detached from the substrate and sinks into the bottom of the carrier unit, or the derivative is detached from the substrate and sinks into the bottom of the carrier unit.

Compared with prior art, the immersion laser fabrication method and the system thereof provided by the present invention can reduce the high temperature of the substrate resulted from the laser fabrication by disposing the substrate in a liquid medium. In addition, an excess substrate or the derivative generated by the above processing can be deposited in the liquid without contaminating the air. In addition, a good cutting and drilling effect is provided by the stable water by means of a low flow rate or a stationary liquid. Since a stable state can be provided by the cutting or drilling process, a hole diameter, a cutting shape, and cut surface quality can be controlled.

### BRIEF DESCRIPTION OF THE DRAWINGS

FIG. 1 is a schematic flow chart of the immersion laser fabrication method according to the first embodiment of the present invention.

FIG. 2 is a block diagram of the immersion laser fabrication system according to the second embodiment of the present invention

FIG. 3 is a schematic view showing the structure of the immersion laser fabrication system in FIG. 2.

FIG. 4 is a schematic diagram showing the scanning assembly of the immersion laser fabrication system in FIG. 2.

### DETAILED DESCRIPTION OF THE PREFERRED EMBODIMENTS

In order to fully comprehend the objectives, features and efficacy of the present invention, a detailed description is described by the following substantial embodiments in conjunction with the accompanying drawings. The description is as below.

The description of unit, element and component in the present invention uses “one”, “a”, or “an”. The way mentioned above is for convenience, and for general meaning of the category of the present invention. Therefore, the description should be understood as “include one”, “at least one”, and include the singular and plural forms at the same time unless obvious meaning.

The description of comprise, have, include, contain, or another similar semantics has the non-exclusive meaning. For example, an element, structure, product, or device contain multi requirements are not limited in the list of the content, but include another inherent requirement of element, structure, product or device not explicitly listed in the content. In addition, the term “or” is inclusive meaning, and not exclusive meaning.

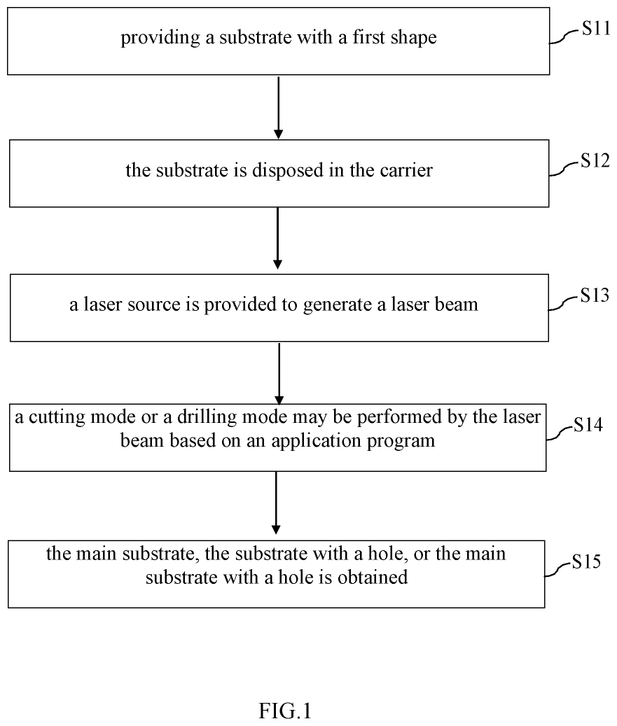

Please refer to FIG. 1, which is a schematic flow chart of an immersion laser fabrication method according to the first embodiment of the present invention. The immersion laser fabrication method starts in step S11 by providing a substrate with a first shape. Wherein a material of the substrate may be a glass, a sapphire, a silicon, a gallium arsenide, a ceramic etc. The first shape may be such as a rectangle, a square etc.

In step S12, the substrate is disposed in the carrier, and the liquid is injected into the carrier, such that the liquid is carried by the carrier, and the liquid may be such as water, glycerin, oil, nano water or a mixture of the above described. In another embodiment, the liquid may also be controlled by temperature to improve the quality of the process. For example, a glycerol plays role as a liquid, the temperature of glycerin can be operated above at one hundred degrees Celsius including 290 degrees Celsius. In another embodiment, the liquid may also have a flow velocity through a mechanism in order to move at a flow velocity in the carrier.

In step S13, a laser source is provided to generate a laser beam. In this embodiment, the laser source may be such as a picosecond laser or a femtosecond laser etc., and the laser beam generated by the laser source may change the physical characteristics of a path, a direction, a power, a focal point, a beam diameter, a focal length etc. by a driving method.

In step S14, a cutting mode or a drilling mode may be performed by the laser beam based on an application program. For example, the physical characteristic of the laser beam may be adjusted by the application program, and the physical characteristic may be at least one of a power, a beam density, a scanning speed or scanning duration, or the laser beam is driven in at least one of a continuous wave (CW) mode, a single pulse mode, a pulse mode and a burst mode by the application program.

In a cutting mode, the substrate may be cut along a second shape (such as a circle, a line, etc.) by the laser beam based on the application program, such that the substrate may be separated into a main substrate (referred to herein as a substrate to be used later) and a sub-substrates (referred to herein as waste, scrap etc.). Further, the sub-substrate may be separated from the main substrate by the cutting of the laser beam, and the sub-substrate is detached from the substrate, and when the specific gravity between the sub-substrate and the liquid is greater than 1, the sub-substrate will sink to the bottom of the carrier.

In a drilling mode, the substrate is drilled at a specific location thereof by the laser beam based on the executed application program in order to form a hole and a derivative in the substrate (referred to herein as a waste generated by drilling). In addition, the derivative generated in the substrate through the drilling of the laser beam may be detached from the substrate, and when the specific gravity between the derivative and the liquid is greater than 1, the derivative will sink to the bottom of the carrier.

Whether in the cutting mode or in the drilling mode, the sub-substrates or the derivatives is generated, furthermore a particle, a dust etc. is generated possibly. The dust is generated from the substrate or is generated after the sintering of the substrate. When the specific gravity between the particle (or dust) and the liquid is greater than 1, the particle (or dust) will also sink to the bottom of the carrier.

In step S15, the main substrate, the substrate with a hole, or the main substrate with a hole is obtained.

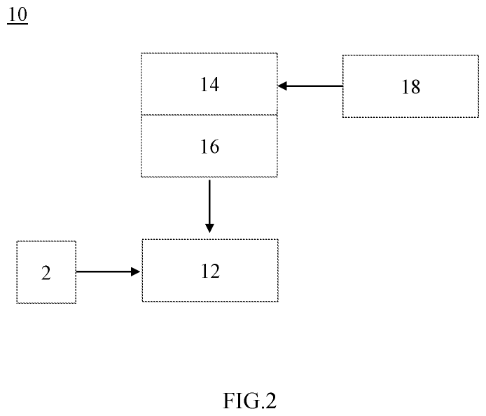

Please refer to FIG. 2, which is a block diagram of an immersion laser fabrication method according to a second embodiment of the present invention. In FIG. 2, the substrate 2 is processed by the immersion laser fabrication system 10, and the material of the substrate 2 may be found in the first implementation.

The immersion laser fabrication system 10 comprises a carrier unit 12, a laser light source unit 14, a holding unit 16, and a processing unit 18.

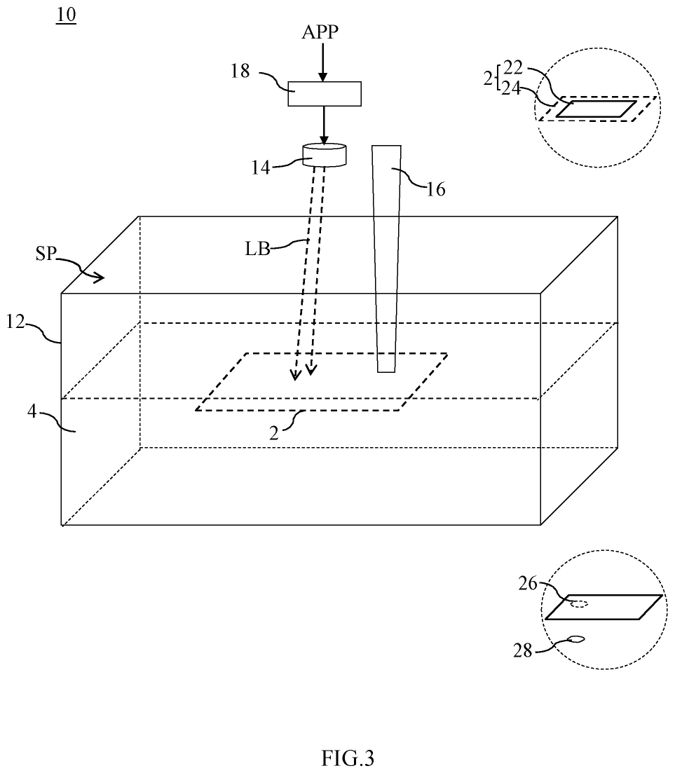

An accommodating space SP is configured by the carrier unit 12 for injecting a liquid 4. Refer to FIG. 3, which is the structural diagram for illustrating FIG. 2. Wherein the liquid 4 may be a water, a glycerin, an oil, a nano water or a mixture thereof. In another embodiment, the accommodating space SP may also be provided with a temperature unit (not shown) for adjusting the temperature of liquid 4, such as a heater or a cooler etc. Herein the carrier unit 12 is exemplified by a tank. In other embodiment, the carrier unit 12 may be a box, such as a box or a cabinet etc. forming the accommodating space SP. The liquid 4 and the substrate 2 can be disposed by the accommodating space SP.

In the present embodiment, the substrate 2 is covered by the liquid 4, e.g. a surface of the substrate 2 is lower than the liquid surface of the liquid 4 (or briefly referred to be a liquid surface). In another embodiment, at least a part (e.g. a surface) of the substrate 2 may be exposed by the liquid surface of the liquid 4. Furthermore, the liquid 4 with a flow velocity or the completely stable liquid 4 is provided in the accommodating space SP. Whether stable or moved liquid 4, it is intended to continuously emit a temperature generated by the laser beam LB applied onto the substrate 2.

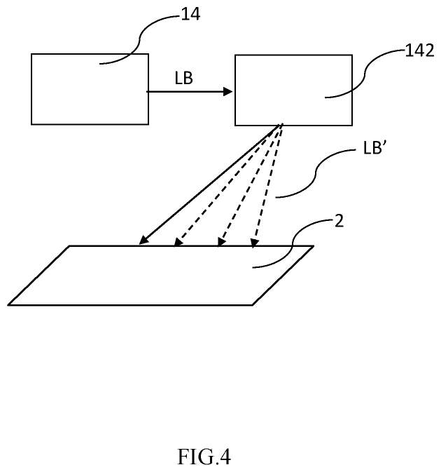

Returning to FIG. 2, the laser light source unit 14 is disposed on an upper side of the carrier unit 12. The laser beam LB is generated by the laser light source unit 14, for example the laser beam is generated by a picosecond laser, a femtosecond laser or the other type of laser. In another embodiment, the wavelength of the laser beam is ranged between 190 nanometers (nm) and 1064 nanometers (nm) or 190 nanometers (nm) and 10600 nanometers (nm). In this embodiment, the laser light source unit 14 may further comprise a mechanical component (such as a gear, a motor, a track, a bearing etc.) (not shown), such that the laser beam LB can transmit along a path (not shown). Please refer to FIG. 4, the laser light source unit 14 further comprises a scanning assembly 142, and an emitting path, ex. an angle or a direction, of the laser beam LB is changed by utilizing the scanning assembly 142 in order to appear the laser beam LB′ at a different position of the substrate 2 with illustratively time passes. The path mentioned above may be illustratively a corresponding shape or a shape of the hole.

Returning to FIG. 2 again, in the embodiment of the mechanical assembly, for example in an illustrative fabrication with low speed, the laser light source unit 14 may be moved in accordance to the path by utilizing a mechanical structure in order to form the corresponding shape or the shape of the hole. In the embodiment of the scanning assembly, for example in an illustrative fabrication with high speed, the scanning assembly 142 can be used to change the emitting position (or the angle) of the laser light source to conform to the path, thereby forming a corresponding shape or shape of the hole. However, the description of high speed/low speed mentioned above does not limit the mechanical structure to operate in a low speed fabrication condition or does not limit the optical structure to operate only in a low speed fabrication condition.

In the present embodiment, the holding unit 16 is disposed above the laser light source unit 14 for the purpose of holding the substrate 2 in order to allow the substrate 2 to be immersed by the liquid 4. For example, the substrate 2 may also be held by utilizing a vacuum suction or a clamp etc. by the holding unit 16. In another embodiment, the holding unit 16 may also be disposed near the carrier unit 12.

The processing unit 18 is connected to the laser light source unit 14. An application program APP may be executed by the processing unit 18 in order to drive the laser beam LB to be applied to the substrate 2 along the path.

For example, the substrate 2 may be cut into a main substrate 22 and a sub-substrate 24, and a relationship between the main substrate 22 and the sub-substrate 24 may be reviewed in the top and enlarged view on the right and atop side of FIG. 3. Alternatively, after drilling the substrate 2, a hole 26 and a derivative 28 is generated in the substrate 2. A relationship between the hole 26 and the derivative 28 may be reviewed in the top and enlarged view on the right and bottom side of FIG. 3. Wherein a diameter of the hole 26 is larger than or the same as 0.05 mm. The sub-substrate and the derivative mentioned above may be referred to be a waste.

In addition, the laser beam LB may be guided to be applied onto the substrate 2 along the path by the application program APP mentioned above, as well as a physical characteristic of the laser beam LB may also be adjusted such that the laser beam LB may be operated to cut a shape of the main substrate 22 or determine an aperture, a depth, a shape etc. of the hole 26. The physical characteristic may be a power, a beam density, a scanning speed, a duration, and the laser beam BL is driven by the laser light source unit 14 in a continuous wave (CW) mode, a single pulse mode, a pulse mode, a Burst mode etc. For example, the laser light source unit 14 is provided with an optical component such as a lens, a prism etc. is provided to adjust a path, a direction, a power, a focal point, a beam diameter, a focal length and so on of laser beam LB.

When the sub-substrate 24 is detached from the substrate 2, the sub-substrate 24 is affected by a force (ex., a gravity, an attractive force, etc.) such that the sub-substrate 24 is moved toward the bottom of the carrier unit 12, or when the derivative 28 is detached from the substrate 2, the derivative 28 is also moved toward the bottom of carrier unit 12 by a gravity influence.

In another embodiment, the immersion laser fabrication system 10 further comprises an acoustic wave generator (not shown). The acoustic wave generator is disposed in the carrier unit 12 in order to generate a vibration; thereby the liquid 4 is disturbed.

In another embodiment, the immersion laser fabrication system 10 further comprises a temperature controlling unit (not shown). The temperature controlling unit is disposed in the accommodating space SP in order to adjust the temperature of liquid 4.

The present invention is disclosed by the preferred embodiment in the aforementioned description; however, it is contemplated for one skilled at the art that the embodiments are applied only for an illustration of the present invention rather than are interpreted as a limitation for the scope of the present invention. It should be noted that the various substantial alternation or replacement equivalent to these embodiments shall be considered as being covered within the scope of the present invention. Therefore, the protection scope of the present invention shall be defined by the claims.

What is claimed is:

1. An immersion laser fabrication method, the method comprises:
S1: providing a substrate with a first shape;
S2: disposing the substrate in a carrier, and a liquid is injected into the carrier;
S3: providing a laser source to generate a laser beam;
S4: cutting the substrate along a second shape by the laser beam based on an application program in order to separate the substrate into a main substrate and a sub-substrate, the sub-substrate is detached from the substrate and sinks to the bottom of the carrier, or the substrate is drilled by the laser beam based on the application program in order to form a hole and a derivative in the substrate, the derivative is detached from the substrate and sinks to the bottom of the carrier, wherein the main substrate is associated with the second shape; and
obtaining the main substrate, the substrate with the hole, or the main substrate with the hole.

2. An immersion laser fabrication system for fabricating a substrate, the immersion laser fabrication system comprises:
a carrier unit configured an accommodating space for injecting a liquid, wherein the accommodating space is used for disposing the substrate, and wherein the substrate is covered by the liquid or at least a part of the substrate is exposed by the surface of the liquid;
a laser light source unit disposed on a side of the carrier unit, and a laser beam is generated by the laser light source unit;
a holding unit disposed near the carrier unit or the laser light source unit, and the holding unit is used for holding the substrate in order to immerse the substrate into the liquid; and
a processing unit connected to the laser light source unit, an application program is executed by the processing unit in order to cut the substrate into a main substrate and a sub-substrate, or form a hole and a derivative in the substrate;
wherein the sub-substrate is detached from the substrate and sinks into the bottom of the carrier unit, or the derivative is detached from the substrate and sinks to the bottom of the carrier unit.

3. The immersion laser fabrication system according to claim 2, wherein the laser beam is directed to move on the substrate by the application program based on a path.

4. The immersion laser fabrication system according to claim 3, wherein the laser light source unit further comprises a mechanical component for operating the laser beam along the path.

5. The immersion laser fabrication system according to claim 3, wherein the laser light source unit further comprises a scanning assembly for operating the laser beam along the path.

6. The immersion laser fabrication system according to claim 2, wherein a physical characteristic of the laser beam is adjusted by the application program, and the physical characteristic is at least one of a power, a beam density, a scanning speed or scanning duration, or the laser beam is driven in at least one of a continuous wave mode, a single pulse mode, a pulse mode and a burst mode by the application program.

7. The immersion laser fabrication system according to claim 2, wherein the laser light source unit further comprises an optical component in order to adjust at least one of a path, a direction, a power, a focal point, a beam diameter and a focal length of the laser beam.

8. The immersion laser fabrication system according to claim 2, wherein the liquid has a flow velocity in the accommodating space in order to continuously dissipate the temperature generated by the laser beam applied on the substrate.

9. The immersion laser fabrication system according to claim 2, wherein the sub-substrate and the derivative are affected by an acting force and move toward the bottom of the carrier unit.

10. The immersion laser fabrication system of claim 2, wherein a wavelength of the laser beam is in the range of between 190 nm and 1064 nm or between 190 nm and 10600 nm, and the liquid is a water, a glycerin, an oil, a nano water or a mixture thereof.

11. The immersion laser fabrication system according to claim 10, further comprises an acoustic wave generator disposed in the carrier unit, and a vibration is generated by the acoustic wave generator in the carrier unit in order to disturb the liquid.

12. The immersion laser fabrication system according to claim 2, further comprises a temperature control unit disposed in the accommodating space in order to adjust a temperature of the liquid.

13. The immersion laser fabrication system according to claim 2, wherein a diameter of the hole is not less than 0.05 mm.
